(19) United States
(12) Patent Application Publication
(10) Pub. No.: US 2025/0363371 A1
(43) Pub. Date: Nov. 27, 2025

(54) METHOD AND SYSTEM FOR LEVERAGING LANGUAGE MODELS IN DESIGNING NO-CODE WORKFLOWS FOR MACHINE LEARNING WITHIN LOW-CODE/NO-CODE PLATFORMS

(71) Applicant: Oracle International Corporation, Redwood Shores, CA (US)

(72) Inventors: Constantin Nicolae, Sandbuckstrasse (CH); Sungpack Hong, Palo Alto, CA (US); Rhicheek Patra, Zurich (CH); Hassan Chafi, Zurich (CH); Margherita Musumeci, Zurich (CH)

(21) Appl. No.: 18/673,185

(22) Filed: May 23, 2024

(51) Int. Cl. G06N 3/0895; G06N 5/04

(52) U.S. Cl. CPC G06N 3/0895; G06N 5/04

(57) ABSTRACT

Here is natural language processing (NLP) for workflow development. A generative large language model (LLM) explains and modifies a workflow graph in an integrated development environment (IDE) that streamlines design, development, and deployment of machine learning (ML) workflows in a low-code/no-code (LC/NC) environment that is productive for users having a wide variety of engineering proficiency. A user is assisted in creating a sophisticated ML workflow through an intuitive and potentially no-code interface. This includes a variety of activities including the generation of code snippets, recommending best ML practices, automatically configuring workflow components, optimizing algorithmic parameters, and providing natural language explanations for each activity. The IDE generates a linguistic prompt that contains a definition of a workflow graph and natural language that specifies an interaction to apply to the workflow graph. The generative LLM accepts the linguistic prompt as input and inferentially generates a result of the interaction for the workflow graph.

### FIELD OF THE INVENTION

The present invention relates to generative natural language processing (NLP) for workflow development. A large language model (LLM) explains and modifies a workflow graph in an integrated development environment (IDE).

### BACKGROUND

Underlying subject matter that is more complex and technical, makes natural language processing (NLP) and natural language interaction (NLI) more difficult. Various descriptive deficiencies may cause inferentially generated natural language to be semantically inaccurate or syntactically ambiguous. For example, semantic inaccuracy may be quantitatively measured by any of the following metrics. Polysemy (i.e. lexical ambiguity) measures the number of possible meanings for individual words. Word error rate (WER) measures words that are typographically incorrect due to, for example, mistaken substitution, insertion, or omission. Metric for evaluation of text retrieval (METEOR) measures semantic fidelity by considering synonym matching and paraphrasing, including stemming and lemmatization. BERTScore measures semantic fidelity and linguistic fluency.

Some sophisticated supervised metrics of semantic inaccuracy are as follows. Bilingual evaluation understudy score (BLEU) is a popular metric for evaluating machine translation, BLEU calculates n-gram (i.e. a short sequence of n words) overlap between a generated text and a preexisting reference text. Likewise, recall-oriented understudy for gisting evaluation (ROUGE) measures overlap between generated text and reference text based on underlying accuracy metrics including recall and precision. Perplexity indirectly measures how fluent and coherent is generated text by measuring how often a next word in a sequence is inaccurately predicted.

Error metrics such as those may quantitatively measure performance of any mode of unreliable text generation such as generative NLP or speech recognition. Thus, semantic and linguistic automation is a technologic problem whose performance may be objectively and empirically inaccurate. For the state of the art to achieve a desired accuracy, which sometimes may be impossible, entails quantifiable computational latency, for which processor time is a precious physical resource of internal operation of a computer.

### BRIEF DESCRIPTION OF THE DRAWINGS

In the drawings:

FIG. 1 is a block diagram that depicts an example integrated development environment (IDE) that performs generative natural language processing (NLP) for workflow development;

FIG. 2 is a flow diagram that depicts an example natural language interaction (NLI) process that any IDE herein may perform;

FIG. 3 is a flow diagram that depicts an example software development lifecycle (SDLC) process that any IDE herein may perform;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

With novel generative natural language processing (NLP) herein for workflow development, a large language model (LLM) explains and modifies a workflow graph in an integrated development environment (IDE). This approach streamlines design, development, and deployment of machine learning (ML) workflows in a low-code/no-code (LC/NC) environment that is productive for users having a wide variety of engineering proficiency. This approach assists a user in creating a sophisticated ML workflow through an ergonomic, intuitive, and potentially no-code interface. This includes a variety of activities including the generation of code snippets, recommending best ML practices, automatically configuring workflow components, optimizing algorithmic parameters, and providing natural language explanations for each activity. In those ways, the impact of this approach may contribute to democratizing the development of ML applications.

Machine learning, with its inherent complexity, requires specialized knowledge to be implemented effectively. The approach herein provides a user with a comprehensive tool that simplifies the design and implementation of ML solutions. This achieves a harmonization of natural language interaction (NLI) and, for example, a multistage ML pipeline, and that combination bridges a divide between simplified application development and advanced ML capabilities. The innovative IDE herein and its special techniques make the software development lifecycle (SDLC) of an ML model more accessible to a broader userbase and irrespective of their expertise at development and operations (dev-ops) and data science.

The LC/NC IDE streamlines creation, management, and execution of an ML workflow in a visual manner that in many cases is no-code. Although the IDE lets an ML expert customize a workflow directly in portions of logic (e.g. low-code), the expert or non-expert user will not be exposed to the underlying ML complexity and writes as little code as possible. This approach automates error-prone workflow operations by translating high level natural language instructions into machine-readable instructions by combining the LC/NC platform with special LLMs capabilities. Configuration and operation of an ML workflow is discussed later herein, and any computer resources spent executing a misconfigured workflow are wasted.

An ML workflow herein has a special underlying representation structure that comprises a workflow graph. The core element of a workflow graph is a vertex that is configured to be a distinct computational unit or step within the workflow. Vertices represent respective tasks, processes, or operations such as data import, transformation, model training, etc. Herein are two special kinds of interactivity that are graphical direct manipulation of the displayed workflow graph or natural language interaction (NLI). In graphical direct manipulation, the user can drag, drop, connect, and interact with nodes to design and visualize a workflow by using a graphical user interface (GUI) panel referred to herein as a canvas. The workflow is interactively defined as a sequential network of operations or tasks, represented graphically by interconnected vertices, and the network is designed to represent and execute an ML workflow.

All workflow operations, interactions, and configurations are formatted as well-structured objects based on a common data-interchange format that is textual such as JavaScript object notation (JSON) or extensible markup language (XML). JSON's inherent structure and readability make it a suitable embodiment to illustrate and infer workflows. LLMs herein are adept at analyzing and generating structured data, including learned semantic and syntactic activities that recognize, manipulate, and generate these JSON objects. This structural representation allows for seamless back-and-forth between the user's natural language commands and the corresponding ML workflow changes. This makes the entire ML lifecycle intuitive, efficient, and highly adaptable. The use of structured language also facilitates special automation such as interpretation and validation of inferentially generated output. In an embodiment, the workflow graph is formatted in JSON to organize the workflow's attributes (e.g. name, identifier, creation date, etc.) and the workflow's components such as vertices, edges, and code execution history as discussed later herein.

With the support of this LC/NC IDE, a user can operate on an ML workflow without worrying about the underline infrastructure and the workflow representation. The IDE is aware of the current status of the workflow without requiring the user to manually enter status into the IDE. The IDE automatically enriches the user's interactively provided natural language with a current snapshot of workflow relevant details to increase accuracy of request fulfillment.

This approach has the following innovations. Generation of workflows with visual interface is a standout feature with its ability to dynamically generate comprehensive ML workflows stemming from the user's input. A generated workflow is displayed in a clear, visual drag-and-drop framework. Instead of only interpreting a series of codes or commands, a user is presented with a holistic visual view of the workflow. This starts from the initial data input stages, through algorithmic processes, and all of the way to the output of the workflow. The user-centered design ensures that workflow vertices can be interactively manipulated, rearranged, or altered by the user. The emphasis on visual representation removes complexity from ML operations, enabling a non-technical user to comprehend, interact with, and fine-tune a workflow.

Human-readable explanation for an LC/NC interface provides comprehension of how well an application is working at fulfilling a certain task. A comprehensible generated explanation might be essential for some users to instill trust in the workflow's operation or to gain a deeper understanding of potential errors.

Automatic user decision support is an ability of the generative LLM to act as an integrated always-available virtual assistant for the LC/NC IDE. This provides an easy way to understand LC/NC application capabilities, limits, and ML best-practices via precise textual guidelines. This facilitates and accelerates interaction with the IDE. The IDE has the following special behaviors.
Integration with Large Language Models: The IDE integrates LLM(s) within the LC/NC platforms. The generative LLM is able to comprehend and generate natural language based on a vast amount of data that the LLM was trained on, and this aspect is leveraged for creating machine learning workflows.
User-friendly No-Code Interface for ML: The IDE allows a user to communicate ML requirements in natural language. In response, the generative LLM suggests, generates, and even optimizes workflows that can be directly executed.
Recommendation of Best Practices: As a user constructs an ML workflow, the system offers best-practice recommendations, ensuring that even a novice can design an efficient ML application. The recommendations range from a) optimized algorithmic-parameter configurations to b) new vertices to insert into the workflow graph.
Auto-Filling Workflow Components: The LLM can auto-fill various components of the workflow, making the design process more streamlined and less error-prone.
Code Snippets Generation: The IDE can reuse existing kinds of vertices or create brand new kinds of vertices with desired new functionalities informally specified in interactive natural language. This overcomes the disparity between the vertex types already available and the functionalities essential to execute a user's custom actions.
Natural Language Explanation: The LLM can act as a virtual assistant guiding the users during their interaction with the tool, providing textual explanation of the execution of the workflow, instructing the user regarding the utilized ML concepts, and providing reference documentation search assistance.

Those innovations and special behaviors provide the following advantages.
Simplicity of Usability: By merging the learned insights of a generative LLM with the visual drag-and-drop interface of an LC/NC platform, a user can easily navigate a complicated ML workflow. This union ensures that ML processes, often regarded as opaque (i.e. black box), become comprehensible and accessible to all users, from beginners to experts.
Efficiency: The interplay between a generative LLM's learned insights and a visual LC/NC representation streamlines the design and deployment lifecycle.
Visual Insights: With a generative LLM providing real-time visual recommendations, a user is not only given suggestions but can interactively discover the rationale behind them. This is a continuous feedback loop that ensures a user progresses towards the most effective ML solution.
Learning with Visualization: The combination of the generative LLM's inferred output and the LC/NC IDE's visual components offers an educational experience that may, for example, gradually increase the skill level of the user. Users can visually trace and comprehend the logic sequences of experimental, defective, or unfamiliar ML workflows.

### 1.0 Example Integrated Development Environment (IDE)

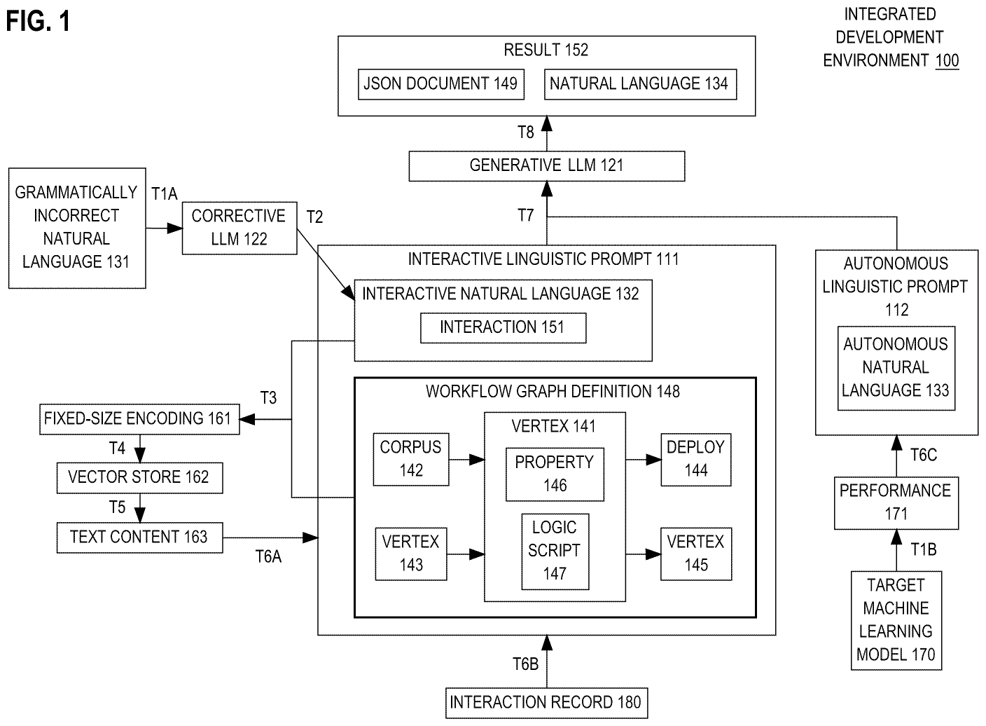

FIG. 1 is a block diagram that depicts an example integrated development environment (IDE) 100 that performs generative natural language processing (NLP) of natural language 131-134 for workflow development. In IDE 100, generative large language model (LLM) 121 explains and modifies workflow graph definition 148. IDE 100 is hosted by one or more computers (not shown) such as a rack server such as a blade, a personal computer, a mainframe, or a virtual computer. All of the components shown in FIG. 1 may be stored and operated in volatile or nonvolatile storage of the computer(s).

Target machine learning (ML) model 170 performs application-specific inferencing for a target application (not shown). In various embodiments, target ML model 170 is at least one of a classifier, a semantic encoder, a semantic decoder, or a numeric regression that, for example, generates a score such as for anomaly detection. Target ML model 170 may have any ML architecture discussed later herein.

IDE 100 is a software application that interactively develops and autonomously monitors target ML model 170. IDE 100 may control the software development lifecycle (SDLC) of target ML model 170 that may be a sequential cycle of repeatable phases such as training, deployment, and monitoring. Depending on which lifecycle phase, instances of target ML model 170 may concurrently exist in one or more separate environments (not shown) such as a software laboratory, a developer personal computer, and in production.

### 1.1 Multistage ML Pipeline

In an embodiment, an operating environment contains an ML pipeline (not shown) that consists of a sequence of stages that build target ML model 170. Example ML pipeline stages in the following sequential ordering include corpus preparation, feature selection, hyperparameter tuning, model training, model validation, and model deployment.

The ML pipeline operates as a workflow that may, for example, include some dataflow as discussed later herein. In one example, the ML pipeline is a linear sequence of stages such that a stage is preceded by at most one immediately upstream stage and followed by at most one immediately downstream stage. In that case, operation of a stage may be preceded by upstream work that already was completed by upstream stage(s) and may be followed by downstream work that will not occur unless and until the stage successfully (i.e. without error) completes. For example: a) the first stage of the pipeline may prepare (i.e. preprocess) a training corpus, for example before target ML model 170 exists, and b) the last stage of the pipeline may deploy target ML model 170 into production.

In a nonlinear example, a strict ordering of all pipeline stages may, for example, underutilize computer(s) and thus unnecessarily increase pipeline latency. For pipeline acceleration, pipeline stages are instead generalized as tasks, and multiple tasks may concurrently execute. For example in sequence: a) a task may receive inputs from multiple concurrent upstream tasks, then b) the task may begin executing when all of its inputs are available, and then c) the task may generate and send output(s) to multiple concurrent downstream tasks for further processing. Thus, a task may have fan-in of inputs and fanout of outputs.

### 1.2 Workflow Graph

In one example, a task generates and sends a same output to two concurrent downstream tasks. In another example, a task generates a first output and a second output and sends the first output to a first downstream task and the second output to a second downstream task. For example, each distinct task may be a distinct vertex in a dataflow graph, and a directed edge connects two vertices to indicate that output generated by an upstream task is accepted as input by a downstream task.

Herein, a workflow graph is a dataflow graph that may contain two kinds of directed edges that are dataflow edges and synchronization edges. A synchronization edge does not transfer data between two tasks but instead prevents execution of a downstream task until an upstream task finishes executing. A vertex is a representation of a task, and herein vertex and task may be synonyms.

Workflow graph definition 148 is a textual definition of a workflow graph that, in this example, defines the tasks and edges of an ML pipeline that builds and deploys target ML model 170. Workflow graph definition 148 is a well-formed semi-structured text document such as JavaScript object notation (JSON) or extensible markup language (XML). Herein, discussion of JSON may instead be implemented with XML.

Well-formed means that workflow graph definition 148 would not cause a parse error if parsed. Semi-structured means that workflow graph definition 148 can be processed with a schema or may instead be schema-less (i.e. processed without a schema). For example, semi-structured may mean that workflow graph definition 148 consists of a mix of parts, where some parts are needed to satisfy a schema and other parts are supplemental (i.e. useful but not expected by the schema).

In some cases, semi-structured may further mean that workflow graph definition 148 may partially consist of natural language (not shown). Natural language 131-134 and unshown natural language parts inside JSON documents 148-149 are collectively referred to as natural language components, which may consist of any of natural word(s) or natural multiword terms or prose such as natural multiword phrases, natural multi-phrase sentences, and/or natural multi-sentence paragraphs.

Workflow graph definition 148 defines a workflow graph and, herein, the workflow graph and its workflow graph definition 148 may be synonyms. IDE 100 can graphically display workflow graph definition 148 as a visual graph or as JSON. In other words, IDE 100 is a graphical user interface (GUI).

### 1.3 Natural Language Interaction (NLI) and Graphical Direct Manipulation are Interactive Modalities

Interactive operation of IDE 100 is as follows. In a (e.g. read only) embodiment, a user may interactively (e.g. by mouse) select one or more vertices and/or edges in workflow graph definition 148. In an embodiment, the mouse pointer hovering over a vertex causes a popup (i.e. tooltip) to be displayed that contains a name, title, summary, or description of the task. In an embodiment, interactive selection of a vertex causes task properties and other task details to be displayed in a side panel in IDE 100.

In an embodiment, IDE 100 supports graphical direct manipulation of workflow graph definition 148 in which the mouse and (e.g. popup) menus and toolbar(s) can be used to interactively directly modify workflow graph definition 148 such as by editing the configuration of an existing vertex or by editing the topology of workflow graph definition 148 by adding or removing vertex(s) or edge(s). IDE 100 provides one or two human computer interaction (HCI) modalities for interacting with workflow graph definition 148. The primary interaction mode is natural language interaction (NLI). An embodiment may or may not have an optional secondary interaction mode that is graphical direct manipulation as discussed above.

The natural language interaction mode is as follows. Herein, NLI entails text processing of interactive text. The user may interactively provide grammatically incorrect natural language 131 by keyboard typing or by voice recognition (i.e. speech to text). Natural language 131-132 both contain interaction 151 that, as discussed later herein, is an informal description of an activity that the user wants IDE 100 to apply to workflow graph definition 148.

### 1.4 Correction of Natural Grammar

In an embodiment that lacks corrective large language model (LLM) 122, natural language 131-132 are identical. As discussed in the above Background, state of the art generative NLP or voice recognition may be semantically or linguistically inaccurate. In a more accurate embodiment, correct interactive natural language 132 is remedially generated from grammatically incorrect natural language 131 as follows.

At shown time T1A, corrective LLM 122 accepts grammatically incorrect natural language 131 as input that may, for example, consist of a sequence of lexical tokens. Corrective LLM 122 already was trained to perform grammar correction on grammatically incorrect natural language 131, which increases accuracy of components 111, 121, 152, and 161 that are discussed later herein. Acceptance of grammatically incorrect natural language 131 as input causes corrective LLM 122 to generatively infer correct interactive natural language 132 at time T2. Although natural language 131-132 have identical semantics, interactive natural language 132 has increased linguistic accuracy.

Internal architecture of any LLM herein may comprise any or all of: a) a receiver or generator of a sequence of lexical tokens that represent the text of a linguistic prompt, b) a deep (i.e. multilayer) neural network (ANN), and c) transformers that are based on attention such as implemented by bidirectional encoder representations from transformers (BERT) or generative pre-trained transformer (GPT). Neural network architecture is discussed later herein.

IDE 100 may generate a corrective linguistic prompt (not shown) by inserting grammatically incorrect natural language 131 into a placeholder enclosed in angle brackets in the following predefined textual template, and corrective LLM 122 accepts the corrective linguistic prompt as input.

Rephrase the following sentence to improve its grammatical
accuracy and overall clarity:
<sentence>

### 1.5 JSON Format of Workflow Graph Definition

Depending on the scenario, interaction 151 may informally specify one of: a) a question about any of components 141-148 and 170, in which case result 152 contains natural language 134 that is an inferentially generated explanation or summary that answers the question as discussed later herein, b) a change to either of components 148 and 170, in which case result 152 contains inferentially generated JSON document 149 that is a new version of workflow graph definition 148 that reflects the requested change as discussed later herein, or c) a new custom task, in which case JSON document 149 is a new version of workflow graph definition 148 that contains a new vertex that contains an inferentially generated logic script as discussed below. All of (a)-(c) are actions that entail generative LLM 121 accepting an input that contains both of text components 132 and 148 at time T7, which causes generative LLM 121 at time T8 to generatively infer result 152 that contains either of result components 134 or 149 but not both. Result 152 is discussed later herein.

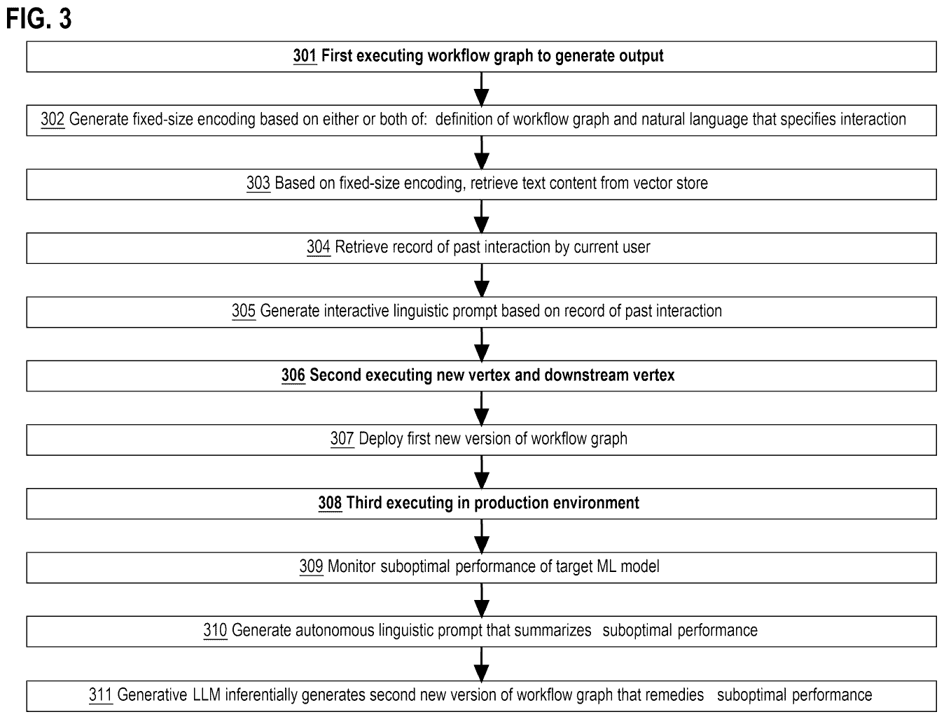

Ellipses indicate truncation for demonstration in the following example JSON document that may be either of JSON documents 148-149. History is discussed later for FIG. 3, and herein a node is a vertex.

```
}
    “name”: “Workflow Name”,
    “id”: “Workflow Id”,
    “version”: 1,
          “creation_date”: “01-01-2023 00:00:00”,
        ... ## additional workflow attributes
        “nodes”: {
            ## The workflow nodes with their configurations and
            attributes needed for
                                    displaying in the UI
        },
    “edges”: {
            ## The workflow edges with their configurations and
            attributes needed for
                                    displaying in the UI
      },
    “jobs”: {
              ## History of workflow node executions
        },
        ... # additional workflow components
  }
```

As discussed elsewhere herein, text components 132 and 148 each is a large variable-sized text that may, for example, contain characters such as punctuation, whitespace, and alphanumeric, including some or many quoted strings. In an embodiment, each of text components 132 and 148 is a respective sequence of lexical tokens (not shown), and the input that generative LLM 121 accepts may contain a concatenation of both sequences into a combined sequence of tokens as discussed later herein.

### 1.6 Task Represented as Vertex

In the shown example, workflow graph definition 148 contains vertices 141-145 that are interconnected by directed edges shown as horizontal arrows. Each vertex may have zero or more properties that are configuration settings specified in workflow graph definition 148. IDE 100 may interactively adjust a property by natural language interaction or by graphical direct manipulation as discussed earlier herein.

Herein, a vertex property may also be referred to as a task property. Each property has a datatype and a value. If the datatype is a data structure, then the value is compound. Otherwise, the value is a scalar (e.g. primitive literal) such as a character string or number.

In the shown example, vertex 141 contains multiple properties 146-147. Logic script 147 is a property in vertex 141 that consists of imperative source code of an algorithm or procedure that implements all or some of the behavior of vertex 141. That source code may be expressed in a domain specific language (DSL) such as structured query language (SQL) or in a general-purpose programing language such as an interpreted language such as JavaScript or python or a compiled language such as C/C++ or Java.

In one example natural language interaction, interaction 151 may informally request changing or generating logic script 147. In one scenario, interaction 151 informally but expressly requests a modification of logic script 147. In another scenario: a) interaction 151 does not expressly mention logic script 147, and b) interaction 151 informally requests a modification of vertex 141 as a task, and generative LLM 121 infers that logic script 147 should be modified. That is an example of low code, which requires the user has minimal programing knowledge, or no code, which requires no programing knowledge and, for example, the user may be unaware of which programing language is logic script 147.

### 1.7 Workflow Interactivity

Herein and regardless of whether or not corrective LLM 122 is present as discussed earlier herein, all natural language interactions are each: a) initiated at a respective occurrence of time T1A as a respective occurrence of natural language 131, b) implemented by generative LLM 121, and c) causal of a respective occurrence of result 152. Thus, there is a one-to-one correspondence of individual distinct natural language interactions to respective distinct occurrences of interaction 151, and this interactivity is the primary mode of operation of IDE 100, with other modes discussed elsewhere herein.

Below are examples of interaction 151 that may cause generation of new vertices or reconfiguration of existing vertices. In some scenarios: a) interactive natural language 132 does not expressly mention a vertex and/or b) the user is unaware of which vertex(s) will be processed by interaction 151. In either of scenarios (a) or (b), generative LLM 121 infers which vertex(s) should be processed by interaction 151.

In one example natural language interaction, interaction 151 may identify a training corpus or validation corpus that should be used to develop target ML model 170, and this causes generation or reconfiguration of corpus 142. As discussed earlier herein, workflow graph definition 148 is a dataflow graph. Vertices/tasks such as corpus 142 may operate as a data source that may inject external data into the dataflow.

As discussed earlier herein, workflow graph definition 148 may be the configuration of an ML pipeline that builds target ML model 170. In one example natural language interaction, interaction 151 may specify how or where to deploy target ML model 170, and this causes generation or reconfiguration of deploy 144 that is a vertex/task that may perform operations involving a deliverable artifact such as: a) generation of a software archive or a containerization image, b) staging of deliverable files into a production filesystem, and c) installation and/or activation of deliverables.

Herein, deployment of either of workflow graphs 148-149 is somewhat separate and related to deployment of target ML model 170. For example, workflow graph definition 148 may be deployed and (e.g. partially) executed but fail before deploy 144 can execute. Herein, execution of a workflow graph may be performed by an ML pipeline.

In various embodiments, IDE 100 operates in a sequence of some or all of times T1-T8. At time T3, text components 132 and 148 exist but interactive linguistic prompt 111 is not generated until time T6 that may entail none, one, or both of times T6A-T6B. Each of times T6A-T6B increases accuracy of components 111, 121, and 152 as follows.

### 1.8 Vector Store Agent for Retrieval Augmented Generation (RAG)

At time T3, fixed-size encoding 161 is generated based on, and as a representation of, either or both of text components 132 and 148 that are not fixed size. In an embodiment, fixed-size encoding 161 is inferred by an encoder ML model (not shown) that may or may not be an LLM. Fixed-size encoding 161 is a one-dimensional array of numbers, also referred to as a one-dimensional numeric vector.

Vector store 162 is an indexed repository that was prepopulated to contain copies, file paths, or uniform resource locators (URLs) of preexisting reference texts such as authoritative or exemplary documents such as a technical manual, a webpage, a frequently asked questions (FAQ) that contains answers, a web log (blog) post, a journal article, or a topic discussion from an online forum of a software engineering or data science community. For example, vector store 162 may provide indexed knowledge about machine learning, programing languages, and administration of systems, networks, and databases.

At time T4, vector store 162 accepts fixed-size encoding 161 as a lookup key for accelerated semantic search of the reference texts. Herein, prepopulated, preexisting, and predefined mean before time T1 such as before or when IDE 100 begins execution. During pre-population of vector store 162, a respective distinct fixed-size encoding is (e.g. inferentially) generated for each reference text. Vector store 162 contains a mapping of each fixed-size encoding to a copy or path of a corresponding reference text.

Herein, a fixed-size encoding is a semantic encoding such that two similar reference texts have similar respective encodings, and a semantic distance between two semantic encodings may be measured by any vector distance metric such as Euclidian, Manhattan, or Mahalanobis. At time T5, vector store 162 returns text content 163 whose fixed-size encoding is most similar to fixed-size encoding 161. At step T6A, part or all of the natural language in text content 163 is expert knowledge that may be copied into interactive linguistic prompt 111 to increase the semantic and contextual accuracy of components 111, 121, and 152. Steps T3-T6A are referred to herein as retrieval augmented generation (RAG), in which case IDE 100 may operate as a vector store agent.

### 1.9 Prompt Engineering for Personalization

Herein, personalization is a way to increase the semantic and contextual accuracy of components 111, 121, and 152 based on the user's recorded history of using IDE 100. For example, interaction record 180 may be one of many entries in a usage log, and each entry may record details of a natural language interaction or a graphical direct manipulation as discussed earlier herein. In an embodiment, interaction record 180 is the most recent one or few log entries in a textual (e.g. JSON) form, referred to herein as session text. Session text may or may not contain natural language. At time T6B: a) interaction record 180 is selected, b) interaction record 180 is formatted as session text, and c) the session text is inserted into interactive linguistic prompt 111. Times T6A-B may be concurrent, after which generation of interactive linguistic prompt 111 is complete.

### 1.10 Multiple Interactive Templates

In an exemplary embodiment, generation of interactive linguistic prompt 111 occurs as follows. Interactive natural language 132 is concatenated with a few natural language sentences that introduce the context of interaction 151 as follows. If generative LLM 121 should process (e.g. but not cause execution of) workflow graph definition 148, then IDE 100 performs: a) automatically retrieves the current or latest workflow execution status from an ML pipeline or from a database, b) formats the workflow execution status as text, and c) inserts that text into interactive linguistic prompt 111 at time T6. Text inserted into interactive linguistic prompt 111 at time T6 may include platform constraints of the ML pipeline itself and of its hardware, operating system, and virtualization infrastructure. In the exemplary embodiment: a) generative LLM 121 has some freedom in how to satisfy interaction 151, and b) natural language that defines best practice(s) related to interaction 151 is selected by IDE 100 and inserted into interactive linguistic prompt 111 at time T6.

In an embodiment, interactive linguistic prompt 111 is generated from any of the preexisting interactive templates presented below that contain placeholder(s). At time T6, linguistic prompt 111 is instantiated by dynamically copying text components such as 132 and 148 into respective placeholders in the interactive template. In an embodiment, IDE 100 dynamically selects one template from a few interactive templates based on inspection of interaction 151. In the following interactive templates: a) angle brackets enclose a placeholder, b) a task may or may not mean a task/vertex as discussed earlier herein, and c) pronoun you means generative LLM 121, even if the user does not know that components 111 and 121 exist.

If interaction 151 asks for an explanation of workflow graph definition 148, then the following example explanation template may be selected. Here, placeholder <workflow> will be replaced with workflow graph definition 148.
You are required to provide a textual description of a given Machine Learning workflow that depicts a sequence of ML operations represented by interconnected nodes. The textual description should start with some sentences defining what is the final ML goal of the workflow. The workflow may be only partially complete. Please focus on what is present and suggest how it could be improved further.
   Workflow: <workflow>

If interaction 151 informally describes a new task for which new logic script 147 should be generated, then the following example scripting template may be selected. Here, placeholder <task> will be replaced with interactive natural language 132.
You will be given a Python programming task to solve. Please solve the task and provide only the Python function that performs the solution. Ensure that your function has an understandable and descriptive name that reflects its purpose. Include a brief explanation of what the function does and how it achieves the solution. Ensure that your code is well-formatted and follows best practices to enhance readability and maintainability.
   Task: <task>

If interaction 151 asks a technical question about any of components 141-148 or 170, then the following example question RAG template may be selected. Here: a) placeholder <question> will be replaced with interactive natural language 132, b) placeholder <document title> will be replaced with the title of text content 163, and c) placeholder <document body> will be replaced with text content 163.
You will be provided with a document delimited by triple single quotes and a question. Your task is to answer the question using the provided document. If the document does not contain the information needed to answer this question then do your best to produce clear and concise actions to perform and the relative explanation.
   ‘‘‘<document title>\n\n<document body>’’’
   Question: <question>

If interaction 151 informally and expressly or impliedly requests modification of a given vertex, then the following example vertex modification template may be selected.
You will be given a task, along with an initial status of a node (representing a machine learning operation configuration) and valid values that specify details like whether the field is mandatory, the default value, data type, and allowed values for each configuration field. Your objective is to solve the task by updating the initial status to produce the final status.
Task: <task in
natural
language>
Node: <node
type>
Valid Values: <node
valid configuration
values>
Initial Status: <initial
node status>

### Final Status:

If interaction 151 informally and expressly or impliedly requests modification of workflow graph definition 148, then the following graph modification template may be selected.
Given a preliminary status of a Machine Learning workflow depicting a sequence of ML operations represented by interconnected nodes, along with a comprehensive list of all available nodes and valid downstream connections, your task is to devise an improvement strategy for the workflow. This requires you to define a meaningful action that will enhance the workflow itself. You can suggest to include a new node a new connection or optimize the configuration parameters.
   Initial Workflow: <initial workflow status>

### Action:

### 1.11 Autonomous Operation of Ide

As discussed earlier herein, time T1A interactively initiates generation and, at time T7, use of interactive linguistic prompt 111, which herein is referred to as interactive operation of IDE 100. Autonomous operation of IDE 100 does not involve a user. IDE 100 may more or less continuously monitor performance 171 of target ML model 170 and, for example, components 100 and 170 may be hosted by separate respective computers in separate environments. Performance 171 may contain telemetry such as measurements of accuracy and latency of recent operation of target ML model 170 over many inferences.

Autonomous natural language 133 is generated from a preexisting autonomous template that contains placeholders. At time T1B, performance 171 is recorded. At time T6C, autonomous linguistic prompt 112 is generated by dynamically copying measurements from performance 171 into the placeholders in the autonomous template.

At time T7, generative LLM 121 accepts autonomous linguistic prompt 112 as input and inferentially detects either optimal or suboptimal performance of target ML model 170. If performance 171 is detected as optimal, then: a) time T8 does not occur, b) result 152 is not generated, and c) IDE 100 will not disturb the configuration of target ML model 170.

If performance 171 is detected as suboptimal then, at time T8, generative LLM 121 generatively infers result 152 that contains a recommended change to the configuration of target ML model 170. Linguistic prompts 111-112 are mutually exclusive such that, at time T7, only one of linguistic prompts 111-112 is available as input to generative LLM 121.

From autonomous linguistic prompt 112, result 152 may be an inferentially generated proposal that contains either or both of: a) JSON document 149 is a new version of the workflow graph of target ML model 170 that, if used, would cause better performance than performance 171, and b) natural language 134 is prose that specifies a change to the workflow graph of target ML model 170 that, if applied, would cause better performance than performance 171. The user may interactively accept or decline the proposal.

In one scenario, the proposal is a first inference to which the user responds by in sequence: 1) interactively submitting natural language 131 to solicit a second result of a second inference by generative LLM 121, and the second result may contain natural language 134 that is a summary or an explanation of a problem or a solution, and then 2) as a better informed manual decision, accepting the proposal, in which case IDE 100 reconfigures target ML model 170 by deploying and causing execution of JSON document 149. Thus, generation of the proposal is autonomous, and deciding for or against the proposal is interactive. In another scenario, the proposal is a first inference to which the user responds by interactively submitting natural language 131 to revise or replace the first result with a second result of a second inference by generative LLM 121. In other words, the user may cause a revised proposal through a collaboration of the user and IDE 100. In that way, result 152 may be a collaborative output that would not be achieved by either the user or IDE 100 alone.

### 2.0 Example Natural Language Interaction (NLI) Process

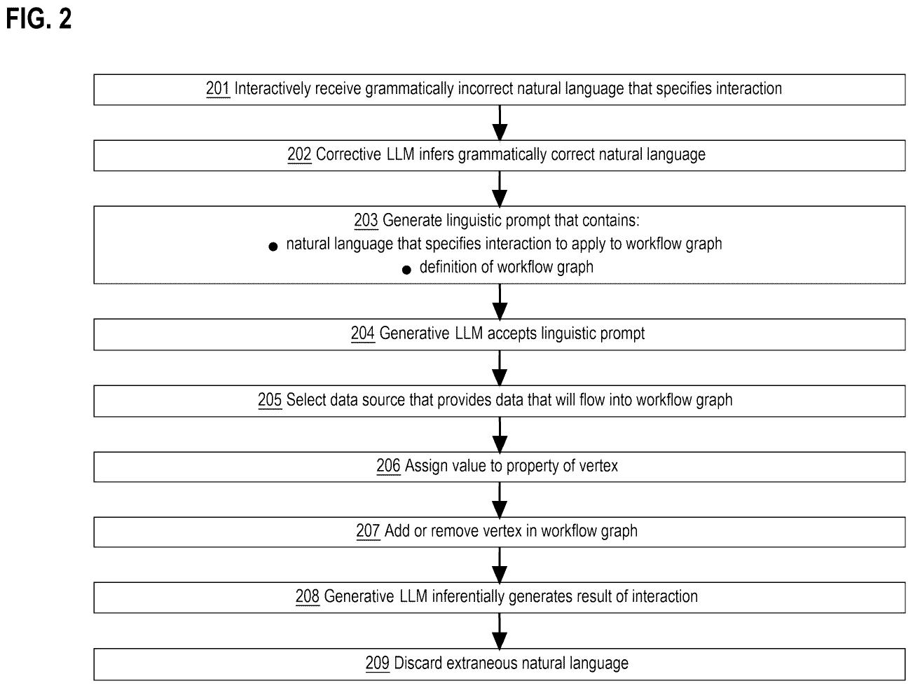

FIG. 2 is a flow diagram that depicts an example computer process that IDE 100 may perform for generative natural language processing (NLP) of natural language 131-134 for workflow development. As discussed earlier herein, IDE 100 has two modes of operation that are autonomous operation in FIG. 3 and interactive operation in FIGS. 2-3. As discussed earlier herein, some of times T1-T8 are dedicated to a scenario or an implementation. Thus, the process of each of FIGS. 2-3 does not expressly show steps for all of times T1-T8. In FIGS. 2-3, some of times T1-T8 may be optional, implied, or omitted and, in some cases, an adjacent few of times T1-T8 may cooccur during a same single step.

At time T1A, step 201 interactively receives grammatically incorrect natural language 131 that informally specifies interaction 151 as discussed earlier herein. At time T2 in step 202, corrective LLM 122 infers grammatically correct interactive natural language 132 as discussed earlier herein.

At time T6, step 203 generates linguistic prompt 132 that contains components 132 and 148 as discussed earlier herein. At time T7 in step 204, generative LLM 121 accepts interactive linguistic prompt 111 as input as discussed earlier herein.

As discussed earlier herein, interaction 151 may informally specify, expressly or impliedly, various manipulative or explanatory activities that generative LLM 121 should perform on the workflow graph for target ML model 170. At time T8, inferential operation of generative LLM 121 may, based on components 132 and 148, entail various example inferential activities that involve learned detections and deductions. Steps 205-207 are various example activities, and none, one, some, or all of these activities may be implicated by interaction 151. In other words, an example natural language interaction (NLI) scenario may entail none, one, some, or all of optional steps 205-207 that occur at time T8 as follows.

Step 205 specifies, in JSON document 149, selection of a data source that will provide data that will flow into the workflow graph. For example, interaction 151 may expressly or impliedly specify a database table, a spreadsheet, a data file, or a data stream, and step 205 inserts a formal reference, such as a file path or URL, to the data source into JSON document 149. For example, the data source may be a training corpus or a validation corpus.

Step 205 may entail specifying either or both of: a) step 206 that assigns the formal reference as a value of a property of a new or existing vertex and b) step 207 that adds a new data source vertex into the workflow graph.

Step 207 specifies adding or removing a vertex in the workflow graph. As discussed earlier herein, an edge in the workflow graph may use an output from an upstream vertex as an input to a downstream vertex. As shown in FIG. 1, vertex 141 has four edges that operate in that way.

For example for demonstration, step 207 may cause inserting new vertex 141 into workflow graph definition 148 as shown in FIG. 1. In that case, step 207 may also insert the four new edges and connect them to respective other vertices 142-145. For example, step 207 may cause generation and configuration of new logic script 147 to accept data from corpus 142 as input. If step 207 removes a vertex, then step 207 also removes all edges connected to the vertex.

Also at time T8, generative LLM 121 inferentially generates result 152 in step 208. For example per step 207, step 208 may generate JSON document 149 that is a new version of the workflow graph that contains multiple more or fewer vertices or edges than workflow graph definition 148 contains.

In an embodiment, result 152 contains extraneous natural language (not shown) that is not contained in components 134 and 149. In that case, step 209 increases the accuracy of result 152 by discarding the extraneous natural language.

### 3.0 Example Software Development Lifecycle (SDLC) Process

FIG. 3 is a flow diagram that depicts an example computer process performed by IDE 100. FIG. 3 provides examples of how interactive operation and autonomous operation of IDE 100 may be synergistic in a software development lifecycle (SDLC) of target ML model 170. FIG. 3 includes an example of debugging a workflow. As discussed earlier herein, vector store 162 is a knowledge base that contains reference material. FIG. 3 provides examples of how the knowledge base, the expertise of the user, and the learned generative LLM 121 are three sources of knowledge that complement each other to increase the accuracy of result 152 and increase the speed, accuracy, and reliability of target ML model 170.

Steps 301, 306, and 308 are shown bold to indicate different executions of the workflow graph for target ML model 170. In this example, the workflow graph executes three times in sequence: 1) first executing by step 301, then 2) second executing by step 306, and then 3) third executing by step 308.

In this example, the first and second executions of the workflow occur in a software laboratory, and the third execution occurs in a production environment. Even though different executions of the workflow graph may respectively occur in different environments, IDE 100 may always execute in the software laboratory, for example, or on a personal computer of a user.

Although interactivity may follow autonomous activity or they may be concurrent, in this example steps 301-307 are interactive and then steps 308-310 are autonomous. In this example, the user can use natural language interaction (NLI) in IDE 100 to interactively cause: a) repeated execution of the workflow graph, including b) editing the workflow graph between the executions. Thus, IDE 100 facilitates an edit-debug cycle whose primary purpose is to increase the speed, accuracy, and reliability of target ML model 170.

### 3.1 Interactive Debugging Process

Debugging may proceed by multiple iterations of the edit-debug cycle. For example, step 301 first executes the workflow graph to generate preliminary output, and later step 306 second executes a first new version of the workflow graph that, based on the preliminary output, is improved to better generate new output. The preliminary output may be any observable effect that needs improvement. For example, the observable effect may be a crash, a malfunction, latency, or inaccuracy.

In this example, each vertex/task in the workflow graph may generate a respective observable effect. For example, a vertex may generate a temporary or intermediate file, or an execution log may contain an entry for each vertex that executed in the workflow. The user may inspect any generated file or log to manually detect a problem. A non-expert user may detect a problem by an inability of the workflow or of target ML model 170 to behave as expected. In any case, the user decides that the first execution of the workflow by step 301 was unsatisfactory.

At time T1A in step 302, the user interactively provides natural language 131, including informally specified interaction 151 that may for example: a) expressly request or specify a change to the workflow graph or b) complain that the first execution of the workflow was unsatisfactory, which generative LLM 121 will treat as an implied request to change the workflow graph.

Step 302 entails times T3-T6A that perform retrieval augmented generation (RAG) to increase the accuracy of components 111, 121, and 152 as discussed earlier herein. At time T3, step 302 generates fixed-size encoding 161 based on either or both of components 132 and 148 as discussed earlier herein. Based on fixed-size encoding 161 at times T4-T5, step 303 retrieves text content 163 from vector store 162.

Because text content 163 is semantically similar to interactive natural language 132 as discussed earlier herein, text content 163 has increased relevance (i.e. accuracy) to the problem that is considered unsatisfactory by the user. In other words, the gist of text content 163 and the intent of the user are highly aligned, which increases the likelihood that the unsatisfactory problem will be resolved by increasing the accuracy of components 111, 121, and 152.

Both of the likelihood that the unsatisfactory problem will be resolved and the accuracy of components 111, 121, and 152 are further increased by personalization at time T6B per step 304 that retrieves past interaction record 180 of the current user as discussed earlier herein. Also at time T6B, step 305 generates interactive linguistic prompt 111 based on interaction record 180 as discussed earlier herein.

After steps 302-305, generative LLM 121 uses highly accurate interactive linguistic prompt 111 to generatively infer a potentially improved first new version of JSON document 149 that is a revised workflow graph. In this example, the revised workflow graph contains a new or modified particular vertex, and none of the vertices upstream from the particular vertex are modified. A naïve test of the revised workflow would re-execute from the beginning of the workflow, including all of the unmodified vertices that are upstream from the particular vertex, which is slow.

In this example, IDE 100 saved the execution history and side effects (e.g. generated files) of the first execution of the workflow by earlier step 301, including inputs and outputs of vertices that executed. Thus for acceleration, step 306 second executes the revised workflow by: a) not executing the unmodified vertices that are upstream from the particular vertex and b) executing the particular vertex and its (e.g. unmodified) downstream vertices. In other words, step 306 resumes execution of the workflow at the particular vertex, which accelerates testing the new or modified particular vertex. For example if the particular vertex is vertex 141, then step 306 reuses the previous outputs of vertices 142-143 as inputs to vertex 141 without re-executing vertices 142-143. In an example having a linear ML pipeline, step 306 resumes execution but not at the first stage of the pipeline.

In this example, the user decides that the second execution by step 306 is satisfactory. In other words, the problem is fixed. In that case, the user may cause IDE 100 to perform step 307 that deploys the fixed version of the workflow graph into a production environment. In that case, step 308 third executes the workflow graph in the production environment.

### 3.2 Autonomous Process for Proposal Generation

The user may subsequently, for awhile, be unavailable and does not use IDE 100. However at time T1B, IDE 100 may continue to autonomously operate, and step 309 continually or periodically monitors performance 171 of target ML model 170, including telemetry such as a crash, a malfunction, latency, or inaccuracy. At time T6C, step 310 generates autonomous linguistic prompt 112 that summarizes performance 171 as discussed earlier herein.

At time T7, generative LLM 121 inferentially detects whether performance 171 is optimal or suboptimal. For example, components 171 and 112 may contain: a) a stack trace or a summary of a core dump of target ML model 170 or b) a performance measurement that exceeds a threshold. If performance 171 is detected as optimal, then time T8 does not occur and result 152 is not generated.

If performance 171 is suboptimal then, at time T8 in step 311, generative LLM 121 inferentially generates a proposal that is a second JSON document 149 that is a second new version of the workflow graph that remedies suboptimal performance 171, which can be proven by interactively deploying the second JSON document 149 into production and repeating times T1B, T6C, and T7. Here, interactive deployment does not occur until the user resumes using IDE 100 and interactively agrees to deploy the second JSON document 149. After redeployment and an unshown fourth execution of the workflow graph, then at time T7 generative LLM 121 will detect that performance 171 has become optimal (i.e. improved). For example, the second JSON document 149 may increase speed or accuracy of internal operation of target ML model 170.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

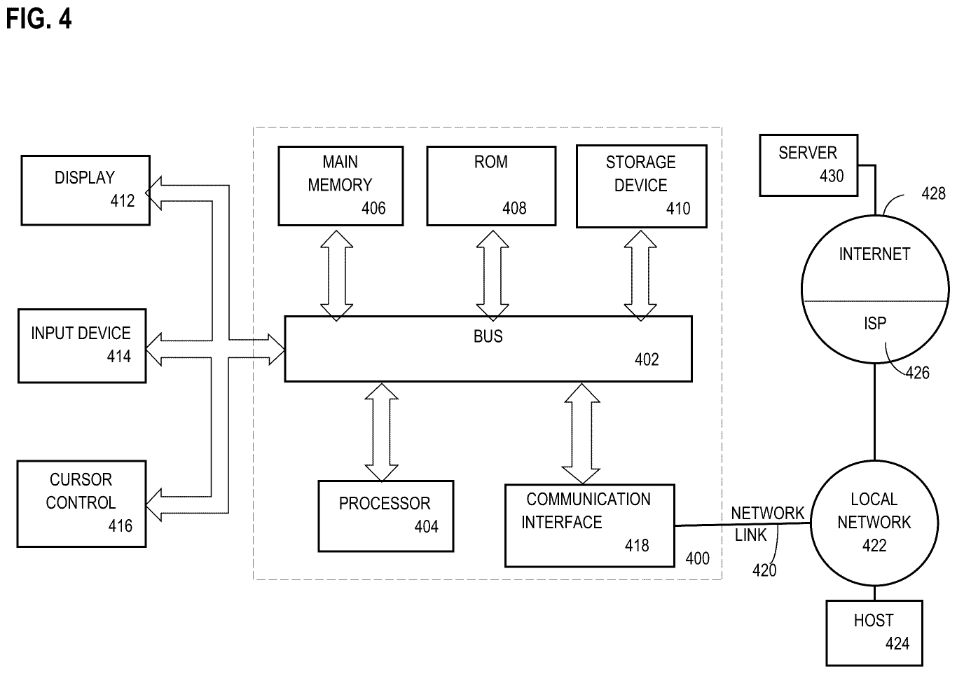

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

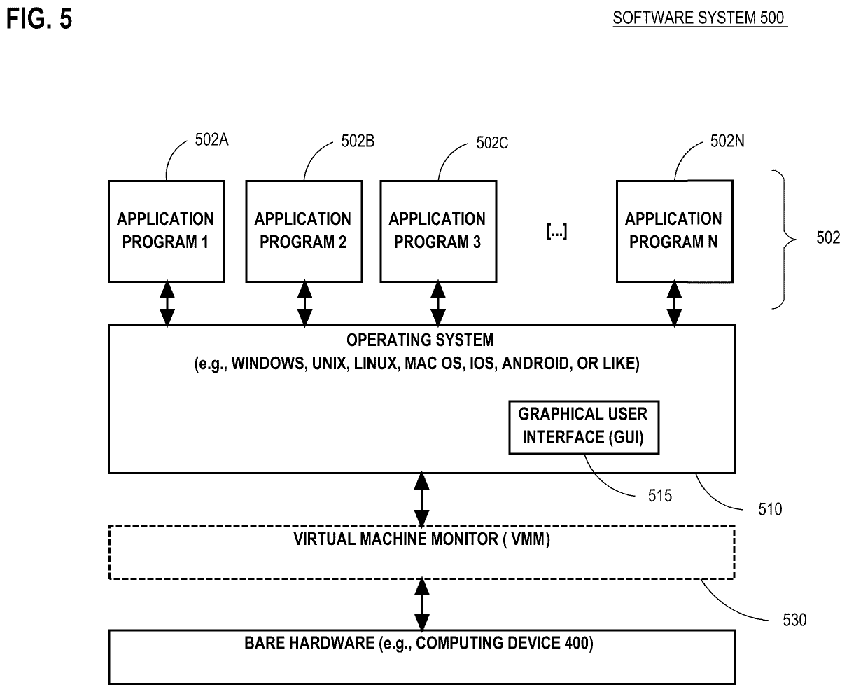

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating a linguistic prompt that contains:
natural language that specifies an interaction to apply to a workflow graph and
a definition of the workflow graph;
accepting, by a large language model (LLM), the linguistic prompt; and
inferentially generating, by the LLM, a result of the interaction for the workflow graph.

2. The method of claim 1 wherein:
the interaction is a change to the workflow graph;
the result of the interaction contains a new version of the workflow graph.

3. The method of claim 2 wherein the change to the workflow graph is at least one change selected from a group consisting of:
an addition or removal of a vertex in the workflow graph,
assignment of a value to a property of a vertex in the workflow graph, and
selection of a data source that provides data that will flow into the workflow graph.

4. The method of claim 2 wherein the change to the workflow graph comprises generating or changing a vertex that specifies one selected from a group consisting of:
a training corpus of a machine learning model,
a validation of a machine learning model, and
a deployment of a machine learning model.

5. The method of claim 2 wherein the new version of the workflow graph comprises a semi-structured document.

6. The method of claim 5 wherein:
said result of the interaction further contains extraneous natural language that the semi-structured document does not contain;
the method further comprises discarding the extraneous natural language.

7. The method of claim 1 wherein:
the interaction comprises an informal definition of a task;
the result of the interaction contains a new vertex in the workflow graph;
the new vertex contains a logic script that performs the task.

8. The method of claim 7 wherein:
the new vertex is connected to an upstream vertex that generates an output;
the logic script accepts the output as an input.

9. The method of claim 8 wherein:
the new vertex is connected to a downstream vertex;
the method further comprises:
first executing, before said generating linguistic prompt, the workflow graph to generate said output, and
second executing, after said inferentially generating the result of the interaction, the workflow graph based on said output;
the second executing comprises executing the new vertex and the downstream vertex;
the second executing does not comprise executing the upstream vertex.

10. The method of claim 1 wherein:
the interaction comprises a question about the workflow graph;
the result of the interaction is an explanation that contains natural language that answers the question about the workflow graph.

11. The method of claim 10 wherein said question is a question about one selected from a group consisting of:
a particular vertex in the workflow graph and
a particular property of a particular vertex in the workflow graph.

12. The method of claim 1 wherein:
said natural language that specifies the interaction is grammatically correct natural language;
the method further comprises:
interactively receiving grammatically incorrect natural language that specifies the interaction, and
generating said grammatically correct natural language from said grammatically incorrect natural language.

13. The method of claim 12 wherein said generating said grammatically correct natural language comprises a second LLM inferring said grammatically correct natural language.

14. The method of claim 1 wherein:
the result of the interaction contains a first new version of the workflow graph;
the method further comprises:
interactively receiving said natural language that specifies the interaction,
deploying the first new version of the workflow graph,
monitoring a suboptimal performance of a machine learning model,
generating a second linguistic prompt that summarizes said suboptimal performance of the machine learning model, and
the LLM inferentially generating a second new version of the workflow graph that remedies said suboptimal performance of the machine learning model;
the second linguistic prompt does not contain natural language that was interactively received.

15. The method of claim 1 wherein:
said definition of the workflow graph and said natural language that specifies the interaction do not have a fixed size;
the method further comprises:
generating a fixed-size encoding based on at least one selected from a group consisting of said definition of the workflow graph and said natural language that specifies the interaction, and
retrieving, based on the fixed-size encoding, text content from a vector store;
said generating the linguistic prompt is based on the text content.

16. The method of claim 1 wherein:
the method further comprises retrieving a record of a past interaction by a current user;
said generating the linguistic prompt is based on the record of the past interaction.

17. One or more non-transitory computer-readable media storing instructions that, when executed by one or more processors, cause:
generating a linguistic prompt that contains:
natural language that specifies an interaction to apply to a workflow graph and
a definition of the workflow graph;
accepting, by a large language model (LLM), the linguistic prompt; and
inferentially generating, by the LLM, a result of the interaction for the workflow graph.

18. The one or more non-transitory computer-readable media of claim 17 wherein:
the interaction is a change to the workflow graph;
the result of the interaction contains a new version of the workflow graph.

19. The one or more non-transitory computer-readable media of claim 17 wherein:
the interaction comprises an informal definition of a task;
the result of the interaction contains a new vertex in the workflow graph;
the new vertex contains a logic script that performs the task.

20. The one or more non-transitory computer-readable media of claim 17 wherein:
the interaction comprises a question about the workflow graph;
the result of the interaction is an explanation that contains natural language that answers the question about the workflow graph.

21. The one or more non-transitory computer-readable media of claim 17 wherein:
the result of the interaction contains a first new version of the workflow graph;
the instructions further cause:
interactively receiving said natural language that specifies the interaction,
deploying the first new version of the workflow graph,
monitoring a suboptimal performance of a machine learning model,
generating a second linguistic prompt that summarizes said suboptimal performance of the machine learning model, and
the LLM inferentially generating a second new version of the workflow graph that remedies said suboptimal performance of the machine learning model;
the second linguistic prompt does not contain natural language that was interactively received.

22. The one or more non-transitory computer-readable media of claim 17 wherein:
the instructions further cause retrieving a record of a past interaction by a current user;
said generating the linguistic prompt is based on the record of the past interaction.
